(19) United States
(12) Patent Application Publication
(10) Pub. No.: US 2017/0094062 A1
(43) Pub. Date: Mar. 30, 2017

(54) IP TELEPHONE SWITCHING SYSTEM AND IP SWITCHING SERVER

(71) Applicant: Kabushiki Kaisha Toshiba, Minato-ku (JP)

(72) Inventor: Satoshi NISHIYAMA, Hino (JP)

(73) Assignee: Kabushiki Kaisha Toshiba, Minato-ku (JP)

(21) Appl. No.: 15/083,494

(22) Filed: Mar. 29, 2016

(30) Foreign Application Priority Data
Sep. 30, 2015 (JP) 2015-193305

(51) Int. Cl. H04M 7/00; H04L 29/06

(52) U.S. Cl. CPC H04M 7/006; H04L 65/1063; H04L 65/1046; H04L 65/1069

(57) ABSTRACT

According to one embodiment, an IP telephone switching system, when processing of transmitting a state notification message is started in an IP switching server, whether it has been already determined that sending messages can be transmitted is determined in the call. If the messages cannot be transmitted, whether the number of destination terminals of the sending messages is greater than or equal to a threshold value is determined. If the number is greater than or equal to the threshold value, network load information is acquired. If the load is greater than or equal to the threshold value, an instruction to execute transmission propriety determination of the state notification message for each terminal.

### CROSS-REFERENCE TO RELATED APPLICATIONS

This application is based upon and claims the benefit of priority from Japanese Patent Application No. 2015-193305, filed Sep. 30, 2015, the entire contents of which are incorporated herein by reference.

### FIELD

Embodiments described herein relate generally to an Internet Protocol (IP) telephone switching system and an IP switching server used for the system.

### BACKGROUND

Recently, Internet Protocol (IP) networks are being increasingly used in telephone switching systems. As the capacity of such an IP telephone switching system increases and the Internet of Things (IoT) becomes widespread, more and more devices are being connected to the network and the traffic volume is expected to increase more than ever. Since cloud computing is increasingly used in the telephone switching system, the traffic volume on a wide-area network (WAN) is also expected to increase.

It should be noted that, when an outgoing or incoming call is made in an IP telephone switching system having an interface related to call processing and an interface related to display, the outgoing or incoming call is displayed in all terminals concerned. This often causes a high volume of traffic on the network depending on system configuration.

As explained above, when an outgoing or incoming call is made in the conventional IP telephone switching system, the outgoing or incoming call is displayed in all terminals concerned, which often causes a high volume of traffic on the network.

Considering the above problem, the embodiment aims to provide an IP telephone switching system capable of controlling transmission of a message by determining whether to transmit the message with respect to an interface related to display and an IP switching server used in the system.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration of an IP telephone switching system of an embodiment.

FIG. 2 is a block diagram showing a configuration of an IP switching server of the system of the embodiment.

FIG. 3 is a block diagram showing a configuration of an IP telephone terminal of the system of the embodiment.

FIG. 4 is an illustration showing a concrete example of terminal state data of the system of the embodiment.

FIG. 5 is a flowchart showing a process regarding message management in the case of changing a terminal state in the IP switching server of the system of the embodiment.

FIG. 6 is a flowchart showing a process regarding message management in the case of acquiring presence information in the IP switching server of the system of the embodiment.

### DETAILED DESCRIPTION

Various embodiments will be described hereinafter with reference to the accompanying drawings.

In general, according to one embodiment, an Internet Protocol (IP) telephone switching system of one embodiment comprises an IP switching server configured to accommodate IP telephone terminals in interfaces having different call control message protocols over an IP network, and to exchange a call control message and a terminal state notification message between the IP telephone terminals. The IP switching server comprises: a call controller configured to determine a sending call control message from combination of a receiving call control message from the IP network and a call state, and to provide an instruction to start transmitting a state notification message when a state of any of the IP telephone terminals is changed; a storage unit configured to store terminal state data indicative of a state of each of the IP telephone terminals; a manager configured to manage the state of each of the IP telephone terminals and to change the terminal state data stored in the storage unit when the state is changed; a call control message processor comprising the interfaces and configured to transmit a call control message to and receive a call control message from the IP telephone terminals accommodated in the interfaces under control of the call controller; a state notification message processor configured to transmit and receive a state notification message under control of the call controller; an overall notification determination unit configured to determine whether to transmit the state notification message to all IP telephone terminals capable of receiving the state notification message when the state notification message is transmitted; and an individual transmission determination unit configured to determine whether to transmit the state notification message to each of the IP telephone terminals when the state notification message is transmitted. The call controller instructs the state notification message processor to transmit the state notification message to all the IP telephone terminals on a condition that: transmission propriety determination has been already executed and a result of the determination is that the state notification message can be transmitted; number of destination terminals of the sending message is less than or equal to a threshold value; or a load on the IP network is less than or equal to a threshold value. The call controller instructs the individual transmission determination unit to execute transmission propriety determination of the state notification message for each IP telephone terminal when none of the above conditions is satisfied. The call controller instructs the state notification message processor to transmit the state notification message to an IP telephone terminal determined by the individual transmission determination unit as a terminal to which the state notification message can be transmitted.

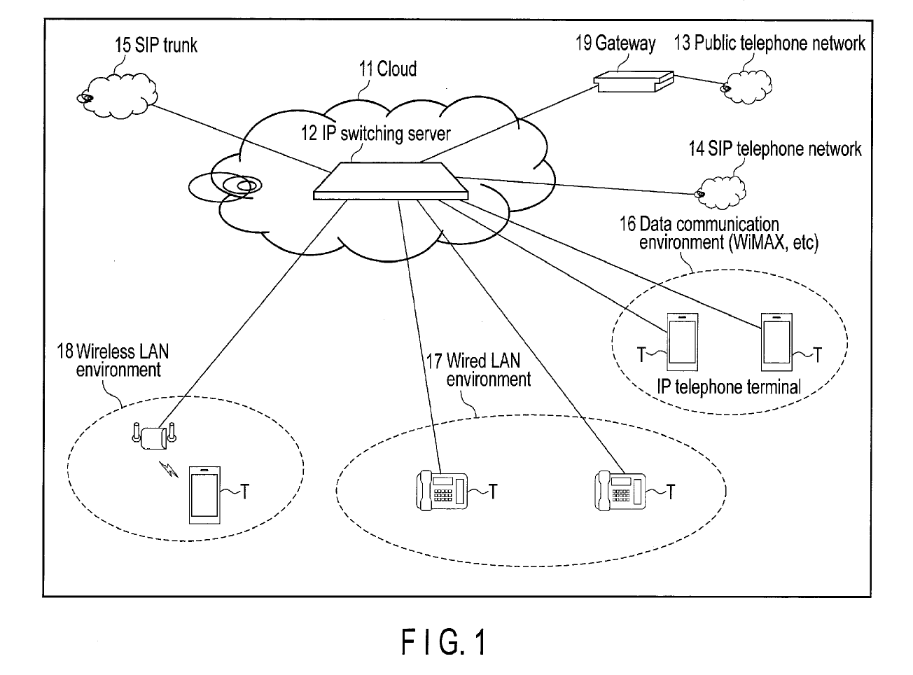

FIG. 1 is a block diagram showing a configuration of an IP telephone switching system of an embodiment. In FIG. 1, an IP switching server 12 is provided in a cloud 11. The IP switching server 12 is externally connected to a public telephone network 13 accommodated in a gateway 19 over the IP network, a session initiation protocol (SIP) telephone network 14, a SIP trunk 15 and the like, and internally connected to a data communication environment (for example, Worldwide Interoperability for Microwave Access [WiMAX] [registered trademark]) 16, a wired LAN environment 17 and a wireless LAN environment 18 capable of accommodating IP telephone terminals T. A call control message and a terminal state notification message are exchanged between the IP telephone terminals via the IP switching server 12.

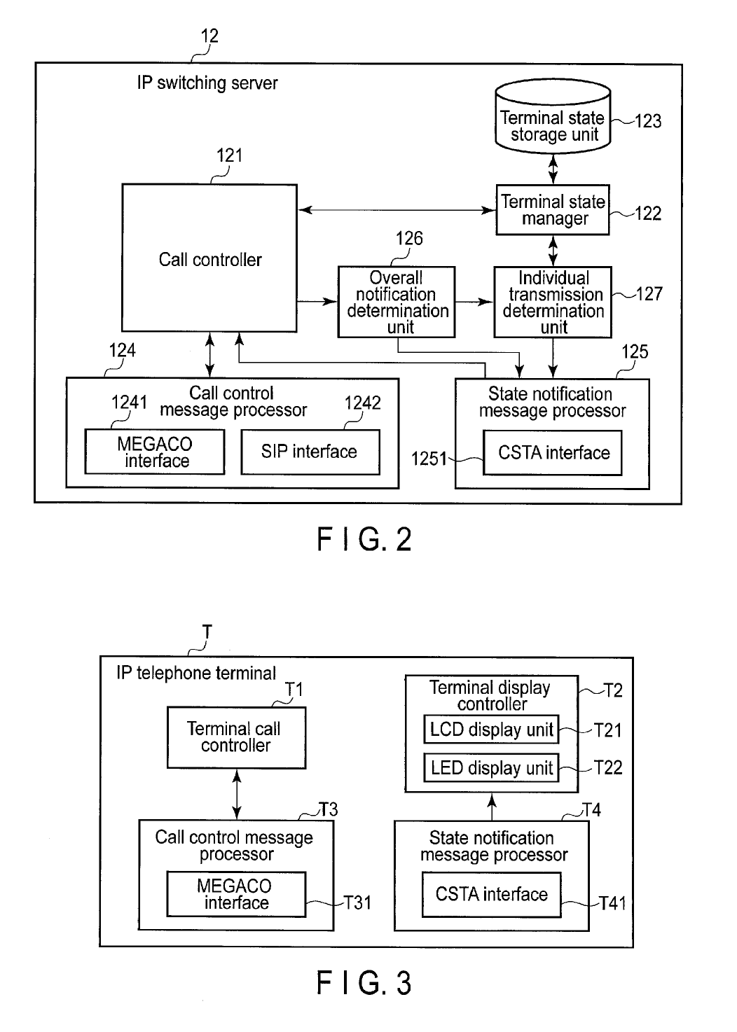

FIG. 2 is a block diagram showing a configuration of the IP switching server 12. As shown in FIG. 2, the IP switching server 12 comprises a call controller 121, a terminal state manager 122, a terminal state storage unit 123, a call control message processor 124, a state notification message processor 125, an overall notification determination unit 126 and an individual transmission determination unit 127.

The call controller 121 processes a received call control message and controls all calls transmitted via the IP switching server 12. The call controller 121 executes appropriate processing based on a call state and the received call control message and determines a call control message to be transmitted. When a change is made in a state of a terminal, the call controller 121 instructs the terminal state manager 122 to change terminal state data and starts processing of transmitting a state notification message. The terminal state manager 122 manages states of terminals under control. When a change is made in a state of a terminal, the terminal state manager 122 changes terminal state data of the terminal stored in the terminal state storage unit 123. For each terminal, the terminal state storage unit 123 stores a drive state, a presence state, information about the number of calls, key arrangement and a state of each key.

The call control message processor 124 is configured to transmit and receive a call control message, and comprises a Media Gateway Control Protocol (Megaco/H.248) interface 1241 and a SIP interface 1242 as interfaces of a call control message protocol. The state notification message processor 125 is configured to transmit and receive a state notification message, and comprises a Computer-Supported Telecommunications Applications (CSTA) interface 1251 as an interface of a state notification message protocol. The overall notification determination unit 126 determines whether an outgoing state notification message can be transmitted to all terminals capable of receiving the message. The individual transmission determination unit 127 determines whether the state notification message should be transmitted to each terminal.

FIG. 3 is a block diagram showing a configuration of the IP telephone terminal T. As shown in FIG. 3, the IP telephone terminal T comprises a terminal call controller T1, a terminal display controller T2, a call control message processor T3 and a state notification message processor T4. The terminal display controller T2 comprises a liquid crystal display (LCD) display unit T21 and a light emitting diode (LED) display unit T22, and displays a terminal state by controlling drive of the display units T21 and T22. The call control message processor T3 comprises an interface T31 according to the call control message protocol, and transmits and receives a call control message under instructions from the terminal call controller T1 via the interface T31. The state notification message processor T4 comprises an interface T41 according to the state notification message protocol, and transmits and receives a state notification message under instructions from the terminal display controller T2 via the interface T41.

The above-described IP telephone switching system is characterized by determining whether a message should be transmitted based on classes of outgoing and incoming calls and key operations on the terminal in an interface regarding display of the terminal state, and preventing transmission of the message when the message is unimportant or causes no contradiction even if the message is not transmitted.

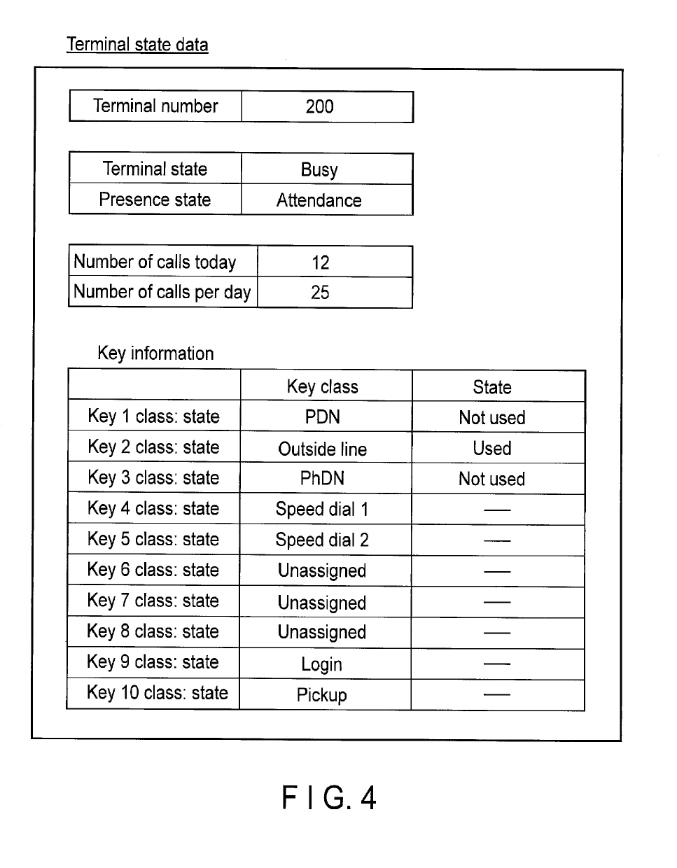

FIG. 4 shows an example the terminal state data. It is hereinafter assumed that the following of each terminal are stored as terminal state data in the terminal state storage unit 123: a terminal state such as a state of being busy, a presence state such as attendance, the number of calls today, the number of calls per day and classes and states of all keys of the terminal.

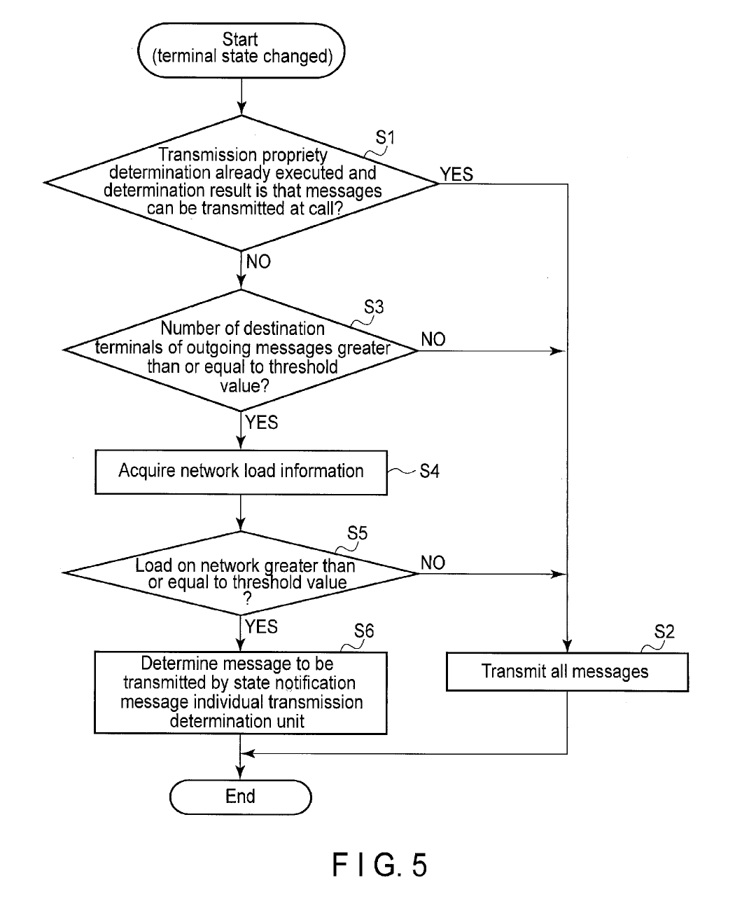

Overall notification propriety determination of a state notification message executed by the overall notification determination unit 126 of the IP switching server 12 of the embodiment is described with reference to a flowchart of FIG. 5.

In FIG. 5, when processing of transmitting a state notification messages is started, whether transmission propriety determination has already been executed and the determination result is that the messages can be transmitted (i.e., whether it has been already determined that the sending messages can be transmitted) at the call is determined (step S1). If the determination result is that the messages can be transmitted (YES), the state notification message processor 125 is instructed to execute processing of transmitting all the messages (step S2). If the determination is not yet executed or the determination result is that the messages cannot be transmitted (NO), whether the number of destination terminals of the sending messages is greater than or equal to a threshold value is determined (step S3). If the number is less than the threshold value (NO), it is considered that a load on the network is small, the process proceeds to step S2 and the state notification message processor 125 is instructed to execute processing of transmitting all the messages. If the number is greater than or equal to the threshold value (YES), network load information such as a bandwidth use ratio is acquired from a device on the cloud (step S4).

Then, whether the load on the network is greater than or equal to a threshold value is determined (step S5). If the load is less than the threshold value (NO), it is considered that the influence on the network is small, the process proceeds to step S2 and the state notification message processor 125 is instructed to execute processing of transmitting all the messages. If the load is greater than or equal to the threshold value (YES), the individual transmission determination unit 127 is instructed to execute transmission propriety determination of the state notification message for each terminal (step S6).

In the above flow, steps S4 and S5 may be executed before step S3.

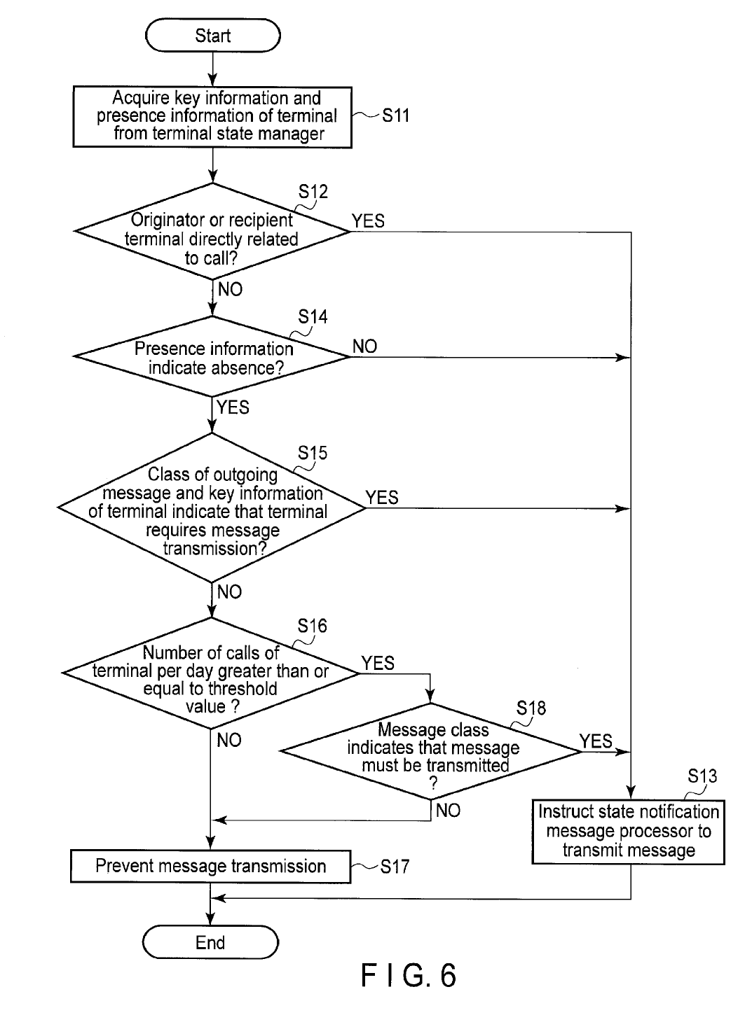

Next, individual transmission propriety determination of the state notification message executed in the individual transmission determination unit 126 of the IP switching server 12 shown in FIG. 2 is described with reference to a flowchart of FIG. 6.

In FIG. 6, when the individual transmission determination unit 126 is instructed to execute transmission propriety determination of the state notification message for each terminal, the individual transmission determination unit 126 executes the following determination for all terminals having a possibility of receiving the state notification message. First, key information and presence information of a terminal are acquired from the terminal state manager 122 (step S11). Based on the information acquired in step S11, whether a destination of the state notification message is an originator or recipient terminal directly related to the call is determined (step S12). If the determination result is YES (i.e., a destination of the state notification message is an originator or recipient terminal directly related to the call), the state notification message processor 125 is instructed to transmit the message (step S13). If the determination result is NO (i.e., a destination of the state notification message is not an originator or recipient terminal directly related to the call), whether the presence information indicates absence is determined based on the information acquired in step Sll (step S14). If the determination result is NO (attendance), the process proceeds to step S13 and the state notification message processor 125 is instructed to transmit the message. If the determination result is YES (absence), the process proceeds to step S15.

In step S15, based on the information acquired in step S11, whether the destination terminal requires message transmission is determined from a class of the sending message and the key information of the terminal (step S15). If the determination result is YES (i.e., the destination terminal requires message transmission), the process proceeds to step S13 and the state notification message processor 125 is instructed to transmit the message. If the determination result is NO (i.e., the destination terminal does not require message transmission), the process proceeds to step S16

In step S16, based on the information acquired in step S11, whether the number of calls of the terminal per day is greater than or equal to a threshold value. If the determination result is NO (i.e., the number of calls of the terminal per day is less than the threshold value), processing for preventing transmission of the message is executed (step S17). If the determination result is YES (i.e., the number of calls of the terminal per day is greater than or equal to the threshold value), whether the message must be transmitted (whether the message is important for state display) is determined based on the class of the sending message (step S18). If the determination result is NO (i.e., the message does not have to be transmitted), the process proceeds to step S17 and the processing for preventing transmission of the message is executed. If the determination result is YES (i.e., the message must be transmitted), the process proceeds to step S13 and the state notification message processor 125 is instructed to transmit the message.

As described above, according to the IP telephone switching system of the embodiment, whether the message should be transmitted is determined based on the state of the destination terminal and the class of the sending message. When the message is unimportant or causes no contradiction even if the message is not transmitted, transmission of the message is prevented. Therefore, the amount of transmitted state notification messages can be reduced and the load on the network can be dynamically reduced without influence on call service.

In the above embodiment, the IP switching server 12 is provided in the cloud 11. However, the IP switching server 12 may be provided not in the cloud 11 but on the premises.

Further, a profile of the owner of the terminal may be added to the terminal state data shown in FIG. 4, and profile information such as a post of the owner of the terminal can be used for message transmission propriety determination by the individual transmission determination unit. Furthermore, information on segments of the network may be added to the terminal state data.

In the IP switching server 12 shown in FIG. 2, logic of determining whether to gather several messages into a group and transmit the group may be added to the individual transmission determination unit 127 such that message groups are transmitted from the state notification message processor at intervals. The load on the network can be thereby spread.

In the message transmission propriety determination, unnecessary messages may be sorted for the interfaces of Megaco, SIP and CSTA.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An Internet Protocol (IP) telephone switching system comprising an IP switching server configured to accommodate IP telephone terminals in interfaces having different call control message protocols over an IP network, and to exchange a call control message and a terminal state notification message between the IP telephone terminals,
wherein the IP switching server comprises:
a call controller configured to determine a sending call control message from combination of a receiving call control message from the IP network and a call state, and to provide an instruction to start transmitting a state notification message when a state of any of the IP telephone terminals is changed;
a storage unit configured to store terminal state data indicative of a state of each of the IP telephone terminals;
a manager configured to manage the state of each of the IP telephone terminals and to change the terminal state data stored in the storage unit when the state is changed;
a call control message processor comprising the interfaces and configured to transmit a call control message to and receive a call control message from the IP telephone terminals accommodated in the interfaces under control of the call controller;
a state notification message processor configured to transmit and receive a state notification message under control of the call controller;
an overall notification determination unit configured to determine whether to transmit the state notification message to all IP telephone terminals capable of receiving the state notification message when the state notification message is transmitted; and
an individual transmission determination unit configured to determine whether to transmit the state notification message to each of the IP telephone terminals when the state notification message is transmitted,
the call controller instructs the state notification message processor to transmit the state notification message to all the IP telephone terminals on a condition that: transmission propriety determination has been already executed and a result of the determination is that the state notification message can be transmitted; number of destination terminals of the sending message is less than or equal to a threshold value; or a load on the IP network is less than or equal to a threshold value,
the call controller instructs the individual transmission determination unit to execute transmission propriety determination of the state notification message for each of the IP telephone terminals when none of the above conditions is satisfied, and
the call controller instructs the state notification message processor to transmit the state notification message to an IP telephone terminal determined by the individual transmission determination unit as a terminal to which the state notification message can be transmitted.

2. The IP telephone switching system of claim 1, wherein
the manager manages at least one of a drive state, a presence information, number of calls and key information, as the terminal state data,
when the individual transmission determination unit is instructed to execute transmission propriety determination of the state notification message for each of the IP telephone terminals, the individual transmission determination unit execute transmission propriety determination for every IP telephone terminal which can be a destination of the state notification message,
the individual transmission determination unit acquires the key information and presence information of the IP telephone terminals from the manager, and determines, based on the acquired information, whether any of a condition that the IP telephone terminal is an originator or recipient terminal relating directly to a call, a condition that the presence information indicates attendance, and a condition that the destination terminal requires message transmission is satisfied,
when any of the above conditions is satisfied, the individual transmission determination unit instructs the state notification message processor to transmit the state notification message, and
when none of the above conditions is satisfied, the individual transmission determination unit instructs the state notification message processor to prevent transmission of the state notification message.

3. The IP telephone switching system of claim 1, wherein
in the transmission propriety determination of the state notification message, the individual transmission determination unit sorts unnecessary messages for the interfaces and individually determines whether to transmit the state notification message.

4. An Internet Protocol (IP) switching server configured to accommodate IP telephone terminals in interfaces having different call control message protocols over an IP network, and to exchange a call control message and a terminal state notification message between the IP telephone terminals,
wherein the IP switching server comprises:
a call controller configured to determine a sending call control message from combination of a receiving call control message from the IP network and a call state, and to provide an instruction to start transmitting a state notification message when a state of any of the IP telephone terminals is changed;
a storage unit configured to store terminal state data indicative of a state of each of the IP telephone terminals;
a manager configured to manage the state of each of the IP telephone terminals and to change the terminal state data stored in the storage unit when the state is changed;
a call control message processor comprising the interfaces and configured to transmit a call control message to and receive a call control message from the IP telephone terminals accommodated in the interfaces under control of the call controller;
a state notification message processor configured to transmit and receive a state notification message under control of the call controller;
an overall notification determination unit configured to determine whether to transmit the state notification message to all IP telephone terminals capable of receiving the state notification message when the state notification message is transmitted; and
an individual transmission determination unit configured to determine whether to transmit the state notification message to each of the IP telephone terminals when the state notification message is transmitted,
the call controller instructs the state notification message processor to transmit the state notification message to all the IP telephone terminals on a condition that: transmission propriety determination has been already executed and a result of the determination is that the state notification message can be transmitted; number of destination terminals of the sending message is less than or equal to a threshold value; or a load on the IP network is less than or equal to a threshold value,
the call controller instructs the individual transmission determination unit to execute transmission propriety determination of the state notification message for each of the IP telephone terminals when none of the above conditions is satisfied, and
the call controller instructs the state notification message processor to transmit the state notification message to an IP telephone terminal determined by the individual transmission determination unit as a terminal to which the state notification message can be transmitted.

5. The IP switching server of claim 4, wherein
the manager manages at least one of a drive state, a presence information, number of calls and key information, as the terminal state data,
when the individual transmission determination unit is instructed to execute transmission propriety determination of the state notification message for each of the IP telephone terminals, the individual transmission determination unit execute transmission propriety determination for every IP telephone terminal which can be a destination of the state notification message,
the individual transmission determination unit acquires the key information and presence information of the IP telephone terminals from the manager, and determines, based on the acquired information, whether any of a condition that the IP telephone terminal is an originator or recipient terminal relating directly to a call, a condition that the presence information indicates attendance, and a condition that the destination terminal requires message transmission is satisfied,
when any of the above conditions is satisfied, the individual transmission determination unit instructs the state notification message processor to transmit the state notification message, and
when none of the above conditions is satisfied, the individual transmission determination unit instructs the state notification message processor to prevent transmission of the state notification message.

6. The IP switching server of claim 4, wherein
in the transmission propriety determination of the state notification message, the individual transmission determination unit sorts unnecessary messages for the interfaces and individually determines whether to transmit the state notification message.
